(19) United States
(12) Patent Application Publication
(10) Pub. No.: US 2023/0244919 A1
(43) Pub. Date: Aug. 3, 2023

(54) RESERVOIR COMPUTING APPARATUS AND DATA PROCESSING METHOD

(71) Applicant: TSINGHUA UNIVERSITY, Beijing (CN)

(72) Inventors: Huaqiang WU, Beijing (CN); Xiangpeng LIANG, Beijing (CN); Ya?nan ZHONG, Beijing (CN); Jianshi TANG, Beijing (CN); Bin GAO, Beijing (CN); He QIAN, Beijing (CN)

(73) Assignee: TSINGHUA UNIVERSITY, Beijing (CN)

(21) Appl. No.: 18/097,651

(22) Filed: Jan. 17, 2023

(30) Foreign Application Priority Data
Jan. 17, 2022 (CN) 202210049571.9

(51) Int. Cl. G06N 3/063

(52) U.S. Cl. CPC G06N 3/063

(57) ABSTRACT

At least one embodiment of the present disclosure provides a reservoir computing apparatus and a data processing method. The reservoir computing apparatus includes: a signal input circuit, configured to receive an input signal; a reservoir circuit, including a plurality of reservoir sub-circuits, in which each reservoir sub-circuit includes a mask sub-circuit and a rotating neuron sub-circuit, the mask sub-circuit is configured to perform a first processing on the input signal with a first weight to obtain a first processing result, and the rotating neuron sub-circuit is configured to perform a second processing on the first processing result to obtain a second processing result; and an output layer circuit, configured to multiply a plurality of second processing results by a second weight matrix to obtain a third processing result. The reservoir computing apparatus optimizes operation efficiency and reduces implementation costs.

### CROSS-REFERENCE TO RELATED APPLICATION

The present application claims priority of the Chinese Patent Application No. 202210049571.9, filed on Jan. 17, 2022, the disclosure of which is incorporated herein by reference in its entirety as part of the present application.

### TECHNICAL FIELD

Embodiments of the present disclosure relate to a reservoir computing apparatus and a data processing method.

### BACKGROUND

Reservoir Computing (RC) is an important branch of Recurrent Neural network (RNN). RC was firstly proposed in the early 21st century to solve the problem of gradient explosion and gradient disappearance in RNN training. As an implementation of RNN, the RC network shows strong ability to process timing signals. In recent years, RC has been widely used in biological signal processing, chaotic sequence prediction, pattern recognition and other fields.

### SUMMARY

At least one embodiment of the present disclosure provides a reservoir computing apparatus, which includes: a signal input circuit, configured to receive an input signal; a reservoir circuit, comprising a plurality of reservoir sub-circuits, wherein each reservoir sub-circuit of the plurality of reservoir sub-circuits comprises: a mask sub-circuit, configured to receive the input signal and perform a first processing on the input signal with a first weight to obtain a first processing result, and a rotating neuron sub-circuit, configured to receive the first processing result from the mask sub-circuit, and perform a second processing on the first processing result to perform a dimension raising, a nonlinear operation and a recursive connection to obtain a second processing result; and an output layer circuit, configured to multiply a plurality of second processing results of the plurality of reservoir sub-circuits by a second weight matrix to obtain a third processing result, and output the third processing result.

For example, in the reservoir computing apparatus provided in at least one embodiment of the present disclosure, the mask sub-circuit comprises: an input terminal, configured to receive the input signal; an input weight configuring sub-circuit, configured to receive a control signal that is related to the first weight, and perform the first processing on the input signal, which is received by the input terminal, and the first weight to obtain the first processing result; and an output terminal, configured to output the first processing result of the input weight configuring sub-circuit.

For example, in the reservoir computing apparatus provided in at least one embodiment of the present disclosure, the input weight configuring sub-circuit comprises: an inverter; a plurality of switches, wherein each switch of the plurality of switches comprises: a first switch input terminal, a second switch input terminal, a switch output terminal, and a switch control terminal, the first switch input terminal is connected with an input terminal of the mask sub-circuit to receive the input signal; the inverter is connected with the input terminal of the mask sub-circuit to receive the input signal and inverts the input signal to obtain an inverted input signal; the second switch input terminal is connected with the inverter to receive the inverted input signal; the switch output terminal is connected with the output terminal of the mask sub-circuit; the switch control terminal is configured to receive the control signal and output the input signal that is received by the first switch input terminal or the inverted input signal that is received by the second switch input terminal from the switch output terminal.

For example, in the reservoir computing apparatus provided in at least one embodiment of the present disclosure, the control signal is a random control signal.

For example, in the reservoir computing apparatus provided in at least one embodiment of the present disclosure, the rotating neuron sub-circuit comprises: N front neuron rotor circuits, wherein each front neuron rotor circuit of the N front neuron rotor circuits comprises a first gate signal terminal, a first input terminal, and N first output terminals that are ranked from 1st to Nth; N rear neuron rotor circuits, wherein the N rear neuron rotor circuits are in one-to-one correspondence with the N front neuron rotor circuits, each rear neuron rotor circuit of the N rear neuron rotor circuits comprises a second gate signal terminal, N second input terminals that are ranked from 1st to Nth and a second output terminal; N neuron circuits, wherein a first terminal of an mth neuron circuit of the N neuron circuits is connected with an mth first output terminal of each front neuron rotor circuit of the N front neuron rotor circuits, a second terminal of the mth neuron circuit of the N neuron circuits is connected with an mth second input terminal of each rear neuron rotor circuit of the N rear neuron rotor circuits; a timing control circuit, connected with the first gate signal terminal of each front neuron rotor circuit of the N front neuron rotor circuits, connected with the second gate signal terminal of each rear neuron rotor circuit of the N rear neuron rotor circuits, and configured to generate a gate signal, thereby applying the gate signal to the N front neuron rotor circuits and the N rear neuron rotor circuits, simultaneously, the N front neuron rotor circuits are configured as a whole, such that each front neuron rotor circuit of the N front neuron rotor circuits gates one of the N first output terminals of its own according to the gate signal, and serial numbers of first output terminals that are gated by the N front neuron rotor circuits are different from each other, the N front neuron rotor circuits are configured as a whole, such that each rear neuron rotor circuit of the N rear neuron rotor circuits gates one of the N second input terminals of its own according to the gate signal, and serial numbers of second input terminals that are gated by the N rear neuron rotor circuits are different from each other, a first output terminal of a front neuron rotor circuit and a second input terminal of a rear neuron rotor circuit, which are connected with a same neuron circuit, are simultaneously gated, N is a positive integer greater than 1, m=1, 2, . . . , N.

For example, in the reservoir computing apparatus provided in at least one embodiment of the present disclosure, a value of the gate signal changes with time and causes in N operation cycles: each front neuron rotor circuit of the N front neuron rotor circuits to gate the 1st to the Nth first output terminals of its own, sequentially, and each rear neuron rotor circuit of the rear neuron rotor circuits to gate the 1st to the Nth second input terminals of its own, sequentially.

For example, in the reservoir computing apparatus provided in at least one embodiment of the present disclosure, each neuron circuit of the plurality of neuron circuits comprises: a nonlinear activating circuit; an integrating circuit; and an attenuating circuit, a first terminal of the nonlinear activating circuit is connected with an input terminal of the neuron circuit; a second terminal of the nonlinear activating circuit is connected with an output terminal of the neuron circuit; a first terminal of the integrating circuit is connected with the output terminal of the neuron circuit; a first terminal of the attenuating circuit is connected with the input terminal of the neuron circuit; and a second terminal of the integrating circuit is connected with a second terminal of the attenuating circuit.

For example, in the reservoir computing apparatus provided in at least one embodiment of the present disclosure, the nonlinear activating circuit comprises a diode; a negative electrode of the diode is connected with the output terminal of the neuron circuit; and a positive electrode of the diode is connected with a reference voltage terminal, the integrating circuit comprises an integrating resistor and a capacitor; a first terminal of the integrating resistor is connected with the input terminal of the neuron circuit; a second terminal of the integrating resistor is connected with a first terminal of the capacitor and the output terminal of the neuron circuit; and a second terminal of the capacitor is connected with the reference voltage terminal, the attenuating circuit comprises an attenuating resistor; a first terminal of the attenuating resistor is connected with the output terminal of the neuron circuit; and a second terminal of the attenuating resistor is connected with the reference voltage terminal.

For example, in the reservoir computing apparatus provided in at least one embodiment of the present disclosure, each front neuron rotor circuit is a first multiplexer; and each rear neuron rotor circuit is a second multiplexer.

For example, in the reservoir computing apparatus provided in at least one embodiment of the present disclosure, the timing control circuit comprises: a counter, configured to generate the gate signal under control of a clock signal.

For example, in the reservoir computing apparatus provided in at least one embodiment of the present disclosure, the output layer circuit comprises: a multiply accumulating sub-circuit, configured to multiply the plurality of second processing results by the second weight matrix to obtain the third processing result.

For example, in the reservoir computing apparatus provided in at least one embodiment of the present disclosure, the multiply accumulating sub-circuit comprises a memristor array, the memristor array comprises a plurality of memristors that are arranged in an array, and a plurality of conductance values of the plurality of memristors that are arranged in an array correspond to values of a plurality of elements of the second weight matrix.

For example, in the reservoir computing apparatus provided in at least one embodiment of the present disclosure, the output layer circuit further comprises: a parameter setting sub-circuit, configured to set the conductance value of the memristor array.

At least one embodiment of the present disclosure provides a data processing method, which is used in the reservoir computing apparatus provided by at least one embodiment of the present disclosure, which includes: using the reservoir computing apparatus to perform an inference computing operation; or using the reservoir computing apparatus to perform a training computing operation.

For example, in the data processing method provided in at least one embodiment of the present disclosure, the inference computing operation comprises: receiving the input signal for the inference computing operation through the signal input circuit; performing the first processing on the input signal and the first weight through the reservoir circuit to obtain the first processing result, and performing the second processing on the first processing result to perform the dimension raising, the nonlinear operation and the recursive connection to obtain the plurality of second processing results; multiplying the plurality of second processing results by the second weight matrix through the output layer circuit to obtain the third processing result, and outputting the third processing result.

For example, in the data processing method provided in at least one embodiment of the present disclosure, the training computing operation comprises: receiving the input signal for the training computing operation and a tag value for the input signal through the signal input circuit; performing the first processing on the input signal and the first weight through the reservoir circuit to obtain the first processing result, and performing the second processing on the first processing result to perform the dimension raising, the nonlinear operation and the recursive connection to obtain the plurality of second processing results; multiplying the plurality of second processing results by the second weight matrix through the output layer circuit to obtain the third processing result; calculating an error of the second weight matrix according to the plurality of third processing results and the tag value for the training input signal to update the second weight matrix; and writing an updated second weight matrix into the output layer circuit.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 shows a schematic diagram of a reservoir computing architecture;

FIG. 2 is a schematic diagram of a reservoir computing apparatus provided by at least one embodiment of the present disclosure;

FIG. 3 is a schematic diagram of a mask sub-circuit of a reservoir computing apparatus provided by at least one embodiment of the present disclosure;

FIG. 4A is a schematic block diagram of a rotating neuron sub-circuit of a reservoir computing apparatus provided by at least one embodiment of the present disclosure;

FIG. 4B is a schematic diagram of a rotating neuron sub-circuit of a reservoir computing apparatus provided by at least one embodiment of the present disclosure;

FIG. 5A is a schematic diagram of dynamic characteristics of an exemplary neuron circuit provided by at least one embodiment of the present disclosure;

FIG. 5B is a schematic diagram of an exemplary neuron circuit provided by at least one embodiment of the present disclosure;

FIG. 6 is a schematic diagram of an output layer circuit based on a memristor array provided by at least one embodiment of the present disclosure;

FIG. 7 is a flow chart of a data processing method provided by at least one embodiment of the present disclosure; and

FIG. 8 is a flow chart of another data processing method provided by at least one embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Likewise, the terms “a”, “an”, “one” or “the” etc., do not denote a limitation of quantity, but mean that there is at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The present disclosure is described below through several specific embodiments. To keep the following description of the embodiments of the present disclosure clear and concise, detailed descriptions of well-known functions and well-known components may be omitted. When any component of an embodiment of the present disclosure appears in more than one drawing, the component is denoted by the same reference numeral in each drawing.

In the context of full development of RC algorithm, the method of implementing RC with hardware has also received attention in the field of brain-like computing in the past decade. The RC algorithm implemented with software depends on data storage and processing under the traditional von Neumann architecture. The idea of implementing RC with hardware depends on an architecture that can efficiently mine physical characteristics of elements and implement RC basic functions.

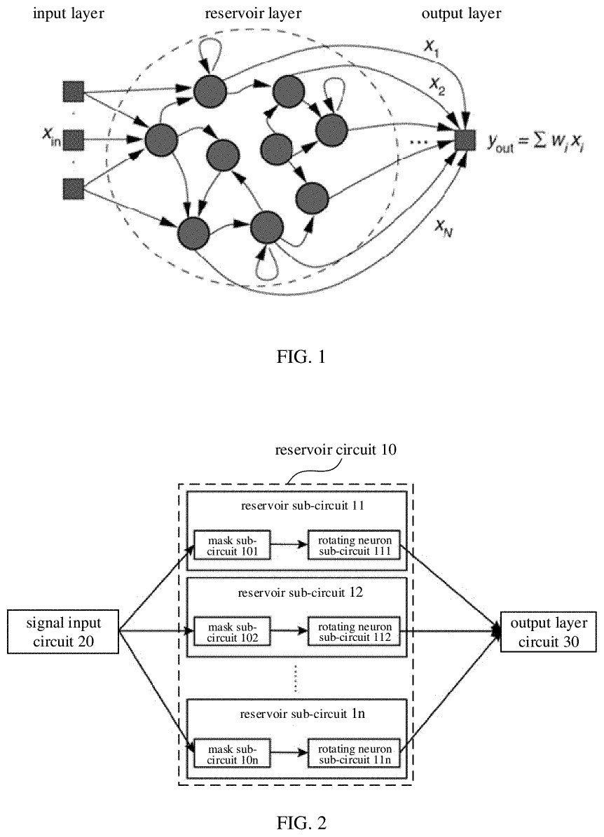

For example, FIG. 1 shows a schematic diagram of a reservoir computing architecture. The reservoir computing architecture consists of three parts, namely, an input layer, a reservoir layer and an output layer. For example, the input layer may be composed of one or more nodes, and belongs to a kind of Feed-forward Neural Network (FNN); the reservoir layer is composed of a plurality of nodes, and belongs to one kind of RNN; and the output layer may be an adder with weights. Specifically, the RC computing process in the reservoir computing architecture may be as shown in formula (1):

yₒᵤₜ=Σᵢ₌₁^{N}(Wᵢxᵢ) (1)

Where i=1, . . . , N, xᵢₙ represents an input signal that is input from the input layer to the reservoir layer, xᵢ represents a reservoir processing result that is input from the reservoir layer to the output layer, yₒᵤₜ represents an output signal that is output from the output layer, and Wᵢ represents a weight matrix of the output layer.

In RC, connection between the input layer and the reservoir layer of the neural network is defined by a randomly generated and fixed matrix; though complex response generated by the matrix with respect to input data, the data is mapped into a high-dimensional and linearly separable feature space. Therefore, training one RC network only requires linear regression that is performed on the high-dimensional state matrix of the output layer, so as to implement some functions of the RNN; and such a characteristic greatly simplifies complexity and reduces costs for training.

As an implementation mode of the RNN, the RC network shows strong ability to process timing signals. In recent years, RC has been widely used in biological signal processing, chaotic sequence prediction, pattern recognition and other fields.

As time-sharing multiplexing and delay feedback loop are introduced into the hardware RC implementation architecture, hardware implementation of RC computing has been further developed. A time-sharing multiplexing operation performed on the input signal reduces the number of required neurons. In addition, since the existence of the delay feedback loop makes the network have certain memory ability, the memory ability is a key to implement RC. In the above-described RC architecture based on delay feedback and time-sharing multiplexing, physical characteristics of a variety of electronic components, optical elements or optoelectronic devices are fully used in machine learning related applications and experiments, which have achieved good results.

The existing RC architecture based on delay feedback and time-sharing multiplexing reduces costs of hardware implementation, but still has obvious defects. First of all, construction of the delay feedback loop still has great overhead and system complexity. For example, in circuit implementation, a digital-to-analog conversion module and a memory are still needed to delay a signal for a period of time; in a photoelectric RC system, the delay line is usually implemented by a section of optical fiber several kilometers long. These implementations all have problems of power consumption or volume; in the absence of a delay feedback loop, memory ability and high-dimensional mapping ability of the RC system are greatly reduced or lost. Secondly, time-sharing multiplexing of input signals increases complexity of the system and brings about a large number of serial operations. These shortcomings hinder the further development and application of the hardware RC system. In the existing RC system, in addition to key physical devices used for computing functions, a large amount of control units and digital-to-analog conversion are usually required to assist operation of the system, or a bulky photoelectric system is needed; however, an ideal brain-like computing unit implemented with RC should be parallel, low-power consuming, simple and efficient.

At least one embodiment of the present disclosure provides a reservoir computing apparatus; the reservoir computing apparatus includes a signal input circuit, a reservoir circuit, and an output layer circuit. The signal input circuit is configured to receive an input signal. The reservoir circuit includes a plurality of reservoir sub-circuits. Each reservoir sub-circuit includes a mask sub-circuit and a rotating neuron sub-circuit. The mask sub-circuit is configured to receive the input signal and perform a first processing on the input signal with a first weight to obtain a first processing result. The rotating neuron sub-circuit is configured to receive the first processing result from the mask sub-circuit, and perform a second processing on the first processing result to perform a dimension raising, a nonlinear operation and a recursive connection to obtain a second processing result. The output layer circuit is configured to multiply a plurality of second processing results of the plurality of reservoir sub-circuits by a second weight matrix to obtain a third processing result, and output the third processing result.

The reservoir computing apparatus periodically switches the connection between a neuron circuit array and input-output circuits to replace functions of the delay feedback and the time-sharing multiplexing in the existing apparatus. The reservoir computing apparatus may implement complete RC functions without other auxiliary circuits, which optimizes operation efficiency and reduces implementation costs.

At least one embodiment of the present disclosure further provides a data processing method corresponding to the above-described reservoir computing apparatus; and the data processing method includes an inference computing or a training computing.

The embodiments of the present disclosure will be described in detail below in conjunction with the accompanying drawings, but the present disclosure is not limited to these specific embodiments.

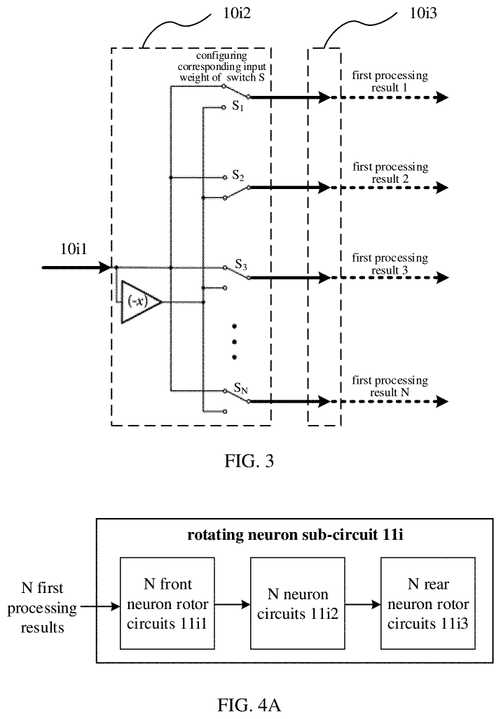

FIG. 2 is a schematic diagram of a reservoir computing apparatus provided by at least one embodiment of the present disclosure.

For example, as shown in FIG. 2, the reservoir computing apparatus includes a signal input circuit 20, a reservoir circuit 10, and an output layer circuit 30. The signal input circuit 20 is configured to receive an input signal. The reservoir circuit 10 includes a plurality of reservoir sub-circuits. Each reservoir sub-circuit includes a mask sub-circuit and a rotating neuron sub-circuit. The mask sub-circuit is configured to receive the input signal and perform a first processing on the input signal with a first weight to obtain a first processing result. The rotating neuron sub-circuit is configured to receive the first processing result from the mask sub-circuit, and perform a second processing on the first processing result to perform a dimension raising, a nonlinear operation and a recursive connection to obtain a second processing result. The output layer circuit 30 is configured to multiply a plurality of second processing results of the plurality of reservoir sub-circuits by a second weight matrix to obtain a third processing result, and output the third processing result.

For example, as shown in FIG. 2, the reservoir circuit 10 includes n reservoir sub-circuits, that is, reservoir sub-circuit 11 to reservoir sub-circuit 1n, where n is a positive integer, for example, n is greater than or equal to 2. Each reservoir sub-circuit includes a mask sub-circuit and a rotating neuron sub-circuit. After receiving the input signal, the signal input circuit 20 outputs the input signal to n mask sub-circuits in the n reservoir sub-circuits in parallel, that is, mask sub-circuit 101 to mask sub-circuit 10n. After receiving the input signal, each mask sub-circuit performs the first processing on the input signal with a first weight to obtain a first processing result and inputs the first processing result to a corresponding rotating neuron. For example, the input signal includes n input signals 1 to n in a form of unit vectors, and the input signals 1 to n are input to n different reservoir sub-circuits 11 to 1n, respectively. A same input signal may be input into a plurality of mask sub-circuits configured with different first weights in parallel, which may improve richness of the state, thereby improving computational performance of the network.

For example, after each rotating neuron sub-circuit receives a plurality of first processing results from a corresponding mask sub-circuit, the rotating neuron sub-circuit will play a major role in computing. The n rotating neuron sub-circuits 111 to 11n perform the second processing on the plurality of first processing results to perform three kinds of processing, namely, a dimension raising, a nonlinear operation and a recursive connection. After operations of the n rotating neuron sub-circuits 111 to 11n, a plurality of second processing results are obtained and input into the output layer circuit 30 in parallel.

For example, the output layer circuit 30 includes a multiply accumulating sub-circuit; for example, the multiply accumulating sub-circuit is implemented by a memory computing integrated array, for example, a memristor array. The multiply accumulating sub-circuit stores the trained second weight matrix. The multiply accumulating sub-circuit is configured to multiply the plurality of second processing results, which are output by the rotating neuron sub-circuits, by the second weight matrix to obtain the third processing result, and output the third processing result. The second weight matrix in the multiply accumulating sub-circuit may configure a target value of a response according to an application scenario, to implement functions such as classification, prediction, and recognition.

FIG. 3 is a schematic diagram of a mask sub-circuit of a reservoir computing apparatus provided by at least one embodiment of the present disclosure.

For example, as shown in FIG. 3, in an ith reservoir sub-circuit 1i of the reservoir circuit 10, a mask sub-circuit 10i includes an input terminal 10i1, an input weight configuring sub-circuit 10i2, and an output terminal 10i3, where i is a positive integer greater than or equal to 1 and less than or equal to n. The input terminal 10i1 is configured to receive an input signal i. The input weight configuring sub-circuit 10i2 is configured to receive a control signal that is related to the first weight. The input weight configuring sub-circuit 10i2 performs the first processing on the input signal i, which is received by the input terminal 10i1, and the first weight to obtain N first processing results. N is a positive integer, for example, greater than or equal to 2. The output terminal 10i3 is configured to output N first processing results of the input weight configuring sub-circuit 10i2, thereby completing the first dimension raising of the input signal.

For example, as shown in FIG. 3, one example of the input weight configuring sub-circuit 10i2 includes an inverter and N switches S₁, S₂ . . . S_{N}. Each switch includes a first switch input terminal, a second switch input terminal, a switch output terminal and a switch control terminal (not shown in FIG. 3). The first switch input terminal is connected with the input terminal 1011 to receive the input signal i (the input signal i is input to the input terminal 1011 through the signal input circuit 20 in FIG. 2). The inverter is connected with the input terminal 1011 to receive the input signal i and inverts the input signal i to obtain an inverted input signal i. The second switch input terminal is connected with the inverter to receive the inverted input signal i. The switch output terminal is connected with the output terminal 10i3. The switch control terminal is configured to receive the control signal and outputs the signal that is received by the first switch input terminal or the second switch input terminal from the switch output terminal.

For example, a specific process of the first processing is that: the input weight configuring sub-circuit 10i2 firstly divides the input signal i into two values, namely, positive value and negative value, through the inverter, and then controls the N switches S₁, S₂ . . . S_{N} through the control signal to respectively select the positive value or the negative value that is input to each neuron, thus applying first weights (here, the weight values are 1 and −1 randomly distributed, respectively). For example, the input signal i firstly passes through an inverter to generate a signal with an amplitude the same as the original signal and with a polarity opposite to the original signal (equivalent to multiply by a weight “−1”). Then, N control signals are respectively input to the switch control terminals of the N switches S₁, S₂ . . . S_{N}, to select whether a switch output terminal of each switch outputs a positive signal or a negative signal, so as to obtain N first processing results 1 to N. The process corresponds to multiplying the input signal i and a corresponding first weight in an RC software algorithm.

For example, in the above-described example, the first weight may be random distribution of N digits of −1 and 1 implemented by the inverter and the N switches S₁, S₂ . . . S_{N}; and in other examples, the first weight may also be a random number between N digits of 0 to 1 implemented in other ways, or other numerical distribution that may implement signal dimension raising and classification processing.

For example, the control signal is a random control signal, and the switch control terminals of the N switches S₁, S₂ . . . S_{N} separately control each switch.

For example, the input signal may be a continuous analog input signal. For example, the inverter may be a reverse operational amplifier circuit. These specific implementations will not be limited in the embodiments of the present disclosure.

It should be noted that, after the debugging of the reservoir computing apparatus is completed or during operation of the reservoir computing apparatus, the n groups of switches controlling the first weight in all n mask sub-circuits must remain unchanged, to ensure that similar responses are generated with respect to similar input signals during using process, for processing by a next level of rotating neuron sub-circuits.

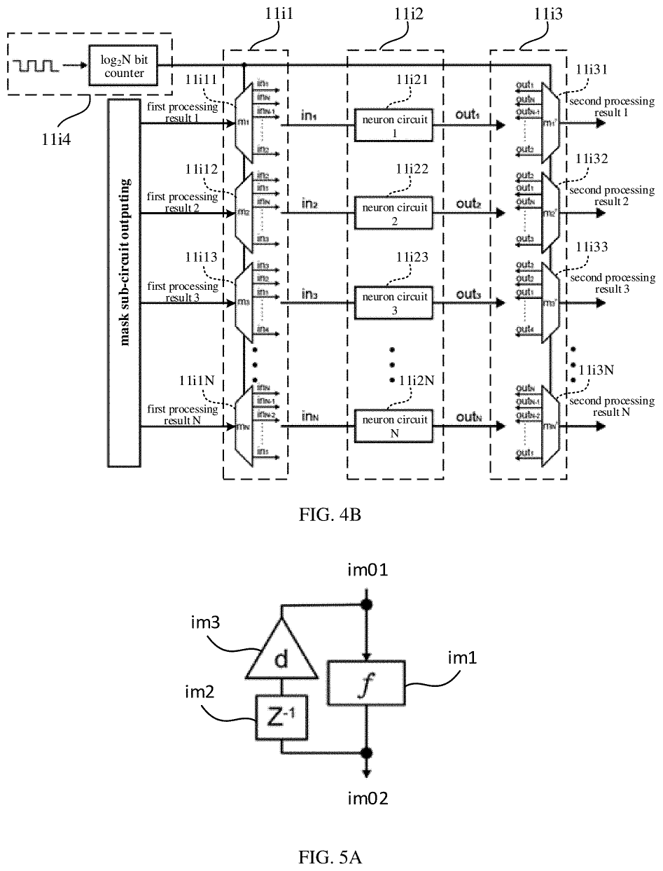

FIG. 4A is a schematic block diagram of a rotating neuron sub-circuit of a reservoir computing apparatus provided by at least one embodiment of the present disclosure; and FIG. 4B is a schematic diagram of an example of a rotating neuron sub-circuit of a reservoir computing apparatus provided by at least one embodiment of the present disclosure.

For example, as shown in FIG. 4A, in the ith reservoir sub-circuit 1i of the reservoir circuit 10, the rotating neuron sub-circuit 11i includes N front neuron rotor circuits 11i1, N neuron circuits 11i2, N rear neuron rotor circuits 11i3, and a timing control circuit 11i4 (as shown in FIG. 4B). Here, N is a positive integer, for example, greater than or equal to 2.

For example, as shown in FIG. 4B, in one example, in the ith rotating neuron sub-circuit, the N front neuron rotor circuits 11i1 include neuron rotor circuits 11i1 to 11i1N (labeled with m₁, m₂, . . . , m_{N}); the N neuron circuits 11i2 include neuron circuits 11i21 to 11i2N; and the N rear neuron rotor circuits 11i3 include rear neuron rotor circuits 11i31 to 11i3N (labeled with m₁′, m₂′, . . . , m_{N}′).

For example, each front neuron rotor circuit includes a first gate signal terminal, a first input terminal and N first output terminals (in₁, in₂, . . . , in_{N}) that are ranked from the 1st to the Nth. Orders of N first output terminals of adjacent front neuron rotor circuits are different; for example, with respect to front neuron rotor circuit 11i11 labeled with m₁, N first output terminals thereof are in₁, in_{N}, . . . , in₂, respectively; with respect to front neuron rotor circuit 11i12 labeled with m₂, N first output terminals thereof are in₂, in₁, . . . , in_{N}, . . . , respectively; and with respect to front neuron rotor circuit 11i1N labeled with m_{N}, N first output terminals thereof are in_{N}, in_{N-1}, . . . , in₁, respectively.

For example, as shown in FIG. 4B, the N rear neuron rotor circuits 11i3 are in one-to-one correspondence with the N front neuron rotor circuits 11i1; each rear neuron rotor circuit includes a second gate signal terminal, N second input terminals (out₁, out₂, . . . , out_{N}) that are ranked from 1st to Nth, and a second output terminal. Orders of N second input terminals of adjacent rear neuron rotor circuits are different; for example, with respect to rear neuron rotor circuit 11i31 labeled with m₁′, N second input terminals thereof are out₁, out_{N}, . . . , out₂, respectively, with respect to rear neuron rotor circuit 11i32 labeled with m₂′, N second input terminals thereof are out₂, out₁, . . . , out_{N}, . . . , respectively, and with respect to rear neuron rotor circuit 11iN labeled with m_{N}, N second input terminals thereof are out_{N}, out_{N-1}, . . . , out₁, respectively.

For example, as shown in FIG. 4B, a first terminal of a neuron circuit 11i2m is connected with an mth first output terminal inₘ of each front neuron rotor circuit, that is, the N first output terminals inₘ of the N front neuron rotor circuits 11i11 to 11i1N are in communication with each other; a second terminal of a neuron circuit 11i2m is connected with an mth second input terminal outₘ of each rear neuron rotor circuit, that is, the N first output terminals outₘ of the N rear neuron rotor circuits 11i21 to 11i2N are in communication with each other; here m=1, 2, . . . , N; and therefore, the neuron circuit 11i2m is connected with the N first output terminals inₘ of the N front neuron rotor circuits 11i1 at a same time, and is connected with the N second input terminals outₘ of the N rear neuron rotor circuits 11i3 at a same time.

For example, each front neuron rotor circuit 110 may be a first multiplexer, that is, one out of N multiplexers, to select one out of the N first output terminals (in₁, in₂, . . . , in_{N}) to be connected with the first input terminal; for example, each rear neuron rotor circuit 130 may be a second multiplexer, that is, one out of N multiplexers, to select one out of the N second input terminals (out₁, out₂, . . . , out_{N}) to be connected with the second output terminal.

For example, the timing control circuit 11i4 includes a counter that is configured to generate a gate signal under control of a clock signal. The timing control circuit 11i4 is connected with a first gate signal terminal of each front neuron rotor circuit, and is connected with the second gate signal terminal of each rear neuron rotor circuit. Therefore, a gate signal is applied to the N front neuron rotor circuits 11i1 and the N rear neuron rotor circuits 11i3, simultaneously, that is, the first gate signal terminals and the second gate signal terminals receive a same gate signal.

It should be noted that the first gate signal terminals of the N front neuron rotor circuits 11i1 and the second gate signal terminals of the N rear neuron rotor circuits 11i3 may receive the same gate signal or different gate signals.

For example, the N front neuron rotor circuits 11i1 are configured as a whole such that each front neuron rotor circuit gates one of the N first output terminals (in₁, in₂, . . . , in_{N}) of its own according to the gate signal, and serial numbers of first output terminals that are gated by the N front neuron rotor circuits 11i1 are different from each other. The N rear neuron rotor circuits 11i3 are configured as a whole, such that each rear neuron rotor circuit gates one of the N second input terminals (out₁, out₂, . . . , out_{N}) of its own according to the gate signal, and serial numbers of second input terminals that are gated by the N rear neuron rotor circuits 11i3 are different from each other. A first output terminal of a front neuron rotor circuit and a second input terminal of a rear neuron rotor circuit, which are connected with a same neuron circuit, are simultaneously gated, thereby obtaining a path from the first input terminal to the second output terminal.

For example, a value of the gate signal changes with time and causes in N operation cycles: each front neuron rotor circuit to gate the 1st to the Nth first output terminals (in₁, in₂, . . . , in_{N}) of its own, sequentially; each rear neuron rotor circuit to gate the 1st to the Nth second input terminals (out₁, out₂, . . . , out_{N}) of its own, sequentially.

For example, as shown in FIG. 4B, the timing control circuit 11i4 may include a counter, for example, the counter is a log₂N bit counter for timing output of a numerical signal, for example, an ascending numerical signal. Each front neuron rotor circuit 110 may be one out of N first multiplexers (m₁, m₂, . . . , m_{N}), and all the first gate signal terminals of the N first multiplexers (m₁, m₂, . . . , m_{N}) are connected with the output terminal of the counter. Each rear neuron rotor circuit 130 may be one out of N second multiplexers (m₁′, m₂′, . . . , m_{N}′), and all the second gate signal terminals of N second multiplexers (m₁′, m₂′, . . . , M_{N}′) are also connected with the output terminal of the counter. When the input terminal of the counter receives a drive pulse signal with a specific frequency, the counter outputs the gate signal to the first gate signal terminals and the second gate signal terminals, simultaneously. The first output terminals (in₁, in₂, . . . , in_{N}) of the first multiplexers of the N front neuron rotor circuits 11i1 and the N second input terminals (out₁, out₂, . . . , out_{N}) of the second multiplexers of the N rear neuron rotor circuits 11i3 are gated, sequentially.

For example, at a certain (1st) moment, the timing control circuit 11i4 outputs a gate signal to the first gate signal terminals and the second gate signal terminals; the gate signal is used to select a first output terminal with a predetermined serial number in the first multiplexers, and is used to select a second input terminal with the same predetermined serial number in the second multiplexers.

For example, at this moment, the gate signal is used to select 1st first output terminals of the first multiplexers and 1st second input terminals of the second multiplexers in FIG. 4B, then the first output terminal in₁ of the first multiplexer m₁ is gated, the first output terminal in₂ of the first multiplexer m₂ is gated, and the first output terminal in₃ of the first multiplexer m₃ is gated . . . ; correspondingly, the second input terminal out₁ of the second multiplexer m₁′ is gated, the second input terminal out₂ of the second multiplexer m₂′ is gated, and the second input terminal out₃ of the second multiplexer m₃′ is gated . . . .

In this case, since the neuron circuit 1 is connected with the first output terminals in₁ of all the first multiplexers and is connected with the second input terminals out₁ of all the second multiplexers, a path from the first input terminal of the first multiplexer m₁ to the first output terminal in₁ of the first multiplexer m₁, the neuron circuit 1, the second input terminal out₁ of the second multiplexer m₁′, and the second output terminal of the second multiplexer m₁′ is obtained; similarly, since the neuron circuit j is connected with the first output terminals inⱼ of all the first multiplexers, and is connected with the second input terminals outⱼ of all the second multiplexers, a path from the first input terminal of the first multiplexer mⱼ to the first output terminal in₁ of the first multiplexer mⱼ, the neuron circuit j, the second input terminal outⱼ of the second multiplexer mⱼ′, and the second output terminal of the second multiplexer mⱼ′ is obtained. Here, j is greater than 1 and less than or equal to N.

For example, at a next (2nd) moment, the gate signal is used to select 2nd first output terminals of the first multiplexers and 2nd second input terminals of the second multiplexers in FIG. 4B; then, the first output terminal in_{N} of the first multiplexer m₁ is gated, the first output terminal in₁ of the first multiplexer m₂ is gated, and the first output terminal in₂ of the first multiplexer m₃ is gated . . . ; correspondingly, the second input terminal out_{N} of the second multiplexer m₁′ is gated, the second input terminal out₁ of the second multiplexer m₂′ is gated, and the second input terminal out₂ of the second multiplexer m₃′ is gated . . . .

In this case, since the neuron circuit 1 is connected with the first output terminals in₁ of all the first multiplexers and is connected with the second input terminals out₁ of all the second multiplexers, a path from the first input terminal of the first multiplexer m₂ to the first output terminal in₁ of the first multiplexer m₂, the neuron circuit 1, the second input terminal out₁ of the second multiplexer m₂′, and the second output terminal of the second multiplexer m₂′ is obtained; similarly, since the neuron circuit j is connected with the first output terminals inⱼ of all the first multiplexers and is connected with the second input terminals outⱼ of all the second multiplexers, a path from the first input terminal of the first multiplexer mⱼ+1 to the first output terminal inⱼ of the first multiplexer mⱼ+₁, the neuron circuit j, the second input terminal outⱼ of the second multiplexer mⱼ+1′, and the second output terminal of the second multiplexer mⱼ+₁′ is obtained. Here, j is greater than 1 and less than N. Since the neuron circuit N is connected with the first output terminals in_{N} of all the first multiplexers and is connected with the second input terminals out_{N} of all the second multiplexers, a path from the first input terminal of the first multiplexer m₁ to the first output terminal in_{N} of the first multiplexer m₁, the neuron circuit N, the second input terminal out_{N} of the second multiplexer m₁′, and the second output terminal of the second multiplexer m₁′ is obtained.

. . .

For example, at an Nth moment, the gate signal is used to select Nth first output terminals of the first multiplexers and Nth second input terminals of the second multiplexers in FIG. 4B, then the first output terminal in₂ of the first multiplexer m₁ is gated, the first output terminal in₃ of the first multiplexer m₂ is gated, and the first output terminal in₄ of the first multiplexer m₃ is gated . . . ; correspondingly, the second input terminal out₂ of the second multiplexer m₁′ is gated, the second input terminal out₃ of the second multiplexer m₂′ is gated, and the second input terminal out₄ of the second multiplexer m₃′ is gated . . . .

In this case, since the neuron circuit 1 is connected with the first output terminals in₁ of all the first multiplexers and is connected with the second input terminals out₁ of all the second multiplexers, a path from the first input terminal of the first multiplexer m_{N} to the first output terminal in₁ of the first multiplexer m_{N}, the neuron circuit 1, the second input terminal out₁ of the second multiplexer m_{N}′, and the second output terminal of the second multiplexer m_{N}′ is obtained; similarly, since the neuron circuit j is connected with the first output terminals inⱼ of all the first multiplexers and is connected with the second input terminals outⱼ of all the second multiplexers, a path from the first input terminal of the first multiplexer mⱼ₋₁ to the first output terminal inⱼ of the first multiplexer mⱼ₋₁, the neuron circuit j, the second input terminal outⱼ of the second multiplexer mⱼ₋₁′, and the second output terminal of the second multiplexer mⱼ₋₁′ is obtained. Here, j is greater than 1 and less than or equal to N.

It may be seen from the above that, at each moment, one neuron circuit may only be connected with one first multiplexer and one second multiplexer, and a case where one neuron circuit is connected with a plurality of first multiplexers or a plurality of second multiplexers simultaneously cannot occur.

Particularly, from the 1st moment to the Nth moment, the second output terminals of the second multiplexer mⱼ′ sequentially outputs signals processed by the neuron circuit j, the neuron circuit j−1, . . . , the neuron circuit 1, the neuron circuit N, the neuron circuit N−1, . . . , and the neuron circuit j+1. Here, j is greater than or equal to 1 and less than or equal to N.

For example, as shown in FIG. 4B, in the ith reservoir sub-circuit 1i of the reservoir circuit 10, a specific process of the rotating neuron sub-circuit 11i performing the second processing on the N first processing results is that: the mask sub-circuit 10i outputs the N first processing results 1 to N to the rotating neuron sub-circuit 11i, that is, a first input terminal of a first multiplexer mⱼ receives a first processing result j that is output from a switch output terminal of a jth switch Sⱼ of the mask sub-circuit. After the first processing result j is input from the first input terminal of the first multiplexer mⱼ, from the 1st moment to the Nth moment, it is processed sequentially by the neuron circuit j, the neuron circuit j−1, . . . , the neuron circuit 1, the neuron circuit N, the neuron circuit N−1, . . . , and the neuron circuit j+1, and is output sequentially from a second output terminal of a second multiplexer mⱼ′ as a second processing result j. Here, i is greater than or equal to 1 and less than or equal to n; here, j is greater than or equal to 1 and less than or equal to N.

For example, in the rotating neuron sub-circuit of the reservoir computing apparatus provided by the above-described embodiment, each front neuron rotor circuit and each rear neuron rotor circuit sequentially polls different neuron circuits, so as to implement an effect of “rotation” of the neuron circuits, which implement dimension raising processing of the signal. The circuit switching process is equivalent to matrix multiplication of ring RC in software algorithm.

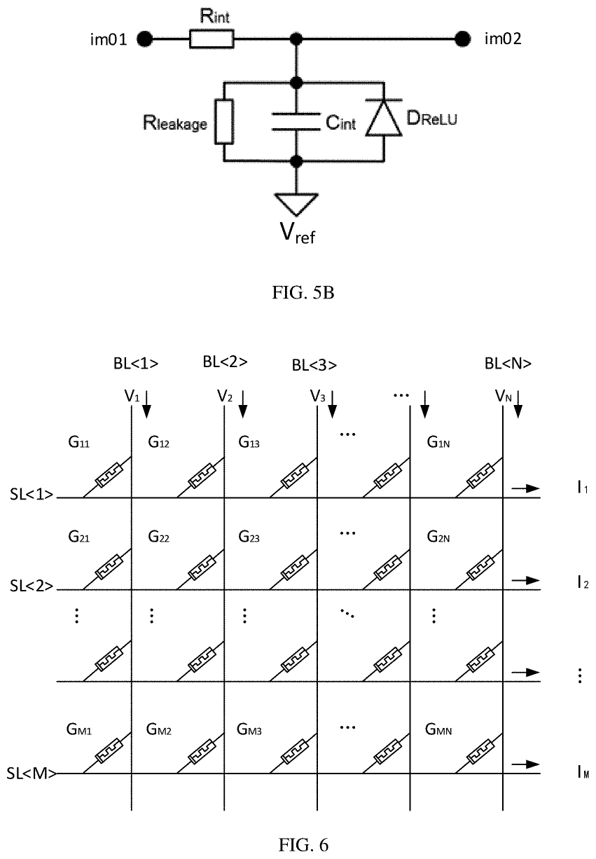

FIG. 5A is a schematic diagram of dynamic characteristics of an exemplary neuron circuit provided by at least one embodiment of the present disclosure; and FIG. 5B is a schematic diagram of an exemplary neuron circuit provided by at least one embodiment of the present disclosure.

For example, as shown in FIG. 5A, each neuron circuit (taking the neuron circuit 11i2m in FIG. 4B as an example) includes a nonlinear activating circuit im1, an integrating circuit im2, and an attenuating circuit im3. A first terminal of the nonlinear activating circuit im1 is connected with an input terminal im01 of the neuron circuit 11i2m, a second terminal of the nonlinear activating circuit im1 is connected with an output terminal im02 of the neuron circuit 11i2m; a first terminal of the integrating circuit im2 is connected with the output terminal im02 of the neuron circuit 11i2m, a first terminal of the attenuating circuit im3 is connected with the input terminal im01 of the neuron circuit 11i2m; and a second terminal of the integrating circuit im2 is connected with a second terminal of the attenuating circuit im3.

For example, as shown in FIG. 5A, the nonlinear activating circuit im1 may correspond to a nonlinear function f; the integrating circuit im2 may correspond to integration Z⁻¹; and the attenuating circuit im3 may correspond to attenuation d during the integration process. After the first processing result m is input from the input terminal im01 to the neuron circuit 11i2m, the nonlinear activating circuit im1 performs nonlinear processing on the first processing result m through the nonlinear function f; the attenuating circuit im3 performs attenuation d on the first processing result m, the integrating circuit im2 performs integration Z⁻¹ on the first processing result after attenuation, and finally the second processing result m after nonlinear and recursive processing is obtained and output from the output terminal im02.

For example, as shown in FIG. 5B, in one example, the nonlinear activating circuit im1 includes a diode D_{ReLU}, a negative electrode of the diode D_{ReLU} is connected with the output terminal im02, and a positive electrode of the diode D_{ReLU} is connected with a reference voltage terminal V_{ref}. The integrating circuit im2 includes an integrating resistor Rᵢₙₜ and a capacitor Cᵢₙₜ; a first terminal of the integrating resistor Rᵢₙₜ is connected with the input terminal im01, a second terminal of the integrating resistor Rᵢₙₜ is connected with a first terminal of the capacitor Cᵢₙₜ and the output terminal im02, and a second terminal of the capacitor Cᵢₙₜ is connected with the reference voltage terminal V_{ref}. The attenuating circuit im3 includes an attenuating resistor R_{leakage}; a first terminal of the attenuating resistor R_{leakage} is connected with the output terminal im02, and a second terminal of the attenuating resistor R_{leakage} is connected with the reference voltage terminal V_{ref}. For example, in the circuit shown in FIG. 5B, the nonlinear equation f is provided by the diode D_{ReLU}; integration Z⁻¹ is provided by Rᵢₙₜ and Cᵢₙₜ; and attenuation d is provided by the resistor R_{leakage}. A resistance value of the resistor R_{leakage} is greater than a resistance value of the integrating resistor Rᵢₙₜ.

It should be noted that the nonlinear activating circuit im1 may also include other components that are capable of providing nonlinear processing functions; the integrating circuit im2 may also include other components that are capable of providing integration processing functions; the attenuating circuit im3 may also include other components that are capable of providing attenuation processing functions. Specific composition of these circuits will not be limited in the embodiments of the present disclosure.

For example, in the neuron circuit provided by the above-described embodiment, due to the integration effect of the integrating circuit on the first processing result input at the past moment, a second processing result output by the neuron circuit at each moment includes information of the first processing result at a current moment and information of the first processing result at a past moment. Therefore, memory characteristics of the neuron circuit per se may keep the input information of the past moment, so that the reservoir computing apparatus does not need additional memory in the simulation computing process, thereby optimizing operation efficiency and reducing implementation costs.

FIG. 6 is a schematic diagram of an output layer circuit 30 based on a memristor array provided by at least one embodiment of the present disclosure.

For example, as shown in FIG. 6, the output layer circuit 30 includes a multiply accumulating sub-circuit and a parameter setting sub-circuit (not shown in FIG. 6). The multiply accumulating sub-circuit includes a memory computing integrated array; the memory computing integrated array may include a memristor array, which is configured to multiply a plurality of second processing results by the second weight matrix to obtain the third processing result. The parameter setting sub-circuit is configured to set a conductance value of the memristor array.

For example, the memristor array of the multiply accumulating sub-circuit includes a plurality of memristors that are arranged in an array. A plurality of conductance values of the plurality of memristors that are arranged in an array correspond to values of a plurality of elements of the second weight matrix.

For example, as shown in FIG. 6, the memristor array is composed of a plurality of memristor sub-circuits; and the plurality of memristor sub-circuits form an array of M rows and R columns, where both M and R are positive integers. Each memristor sub-circuit includes a switching component (e. g., a transistor) and one or more memristors. In FIG. 6, BL<1>, BL<2> . . . BL<R> represent bit lines of a first column, a second column . . . an Rth column, respectively, and memristors in memristor sub-circuits of each column are connected with a corresponding bit line of the column; SL<1>, SL<2> . . . SL<M> represent source lines of a first row, a second row . . . an Mth row, respectively, and source electrodes of switching components in memristor sub-circuits of each row (e.g., source electrodes of the transistors) are connected with a corresponding source line of the row; in addition, control electrodes of switching components in memristor sub-circuits of each row (e.g., gate electrodes of the transistors) are connected with a corresponding word line of the row (not shown n FIG. 6). According to Kirchhoff's law, by setting a state of a memristor sub-circuit (e.g., a resistance value or a conductance value), and by applying a corresponding word line signal and bit line signal to the word line and bit line, the above-described memristor array may complete multiply accumulation in parallel.

For example, each rotating neuron sub-circuit outputs N second processing results, then n rotating neuron sub-circuits in n reservoir sub-circuits output a total of n×N second processing results, i.e. R=n×N.

For example, the R second processing results are voltage outputs (V₁, V₂ . . . , V_{R}), which may be directly used as high-dimensional feature vectors for multiply accumulation of the output layer circuit 30. For example, the plurality of conductance values Gₜ=[G₁₁, G₁₂ . . . G_{1R}; G₂₁, G₂₂ . . . G_{2R}; . . . ; G_{M1}, G_{M2} . . . G_{MR}] of the memristors arranged in M rows and R columns correspond to the values of the plurality of elements of the second weight matrix. The plurality of conductance values of the memristors arranged in M rows and R columns are set by the parameter setting sub-circuit.

For example, the R second processing results (e.g., input voltage vectors Vₜ=[V₁, V₂, . . . , V_{R}]) are input on bit lines BL<1>, BL<2> . . . BL<R>, the R second processing results are multiplied by the second weight matrix (e.g., the conductance matrix Gₜ) of M rows and R columns to obtain M third processing results (e.g., output current vectors Iₜ=[I₁, I₂, . . . , I_{M}]), and the M third processing results are output on source lines SL<1>, SL<2> . . . SL<M>. For example, specific computing process is shown in formula (2).

$$[ \begin{matrix}{G}_{11} & {G}_{12} & … & {G}_{1 R} \\ {G}_{21} & {G}_{22} & … & {G}_{2 R} \\ ⋮ & ⋮ & ⋱ & ⋮ \\ {G}_{M 1} & {G}_{M 2} & … & {G}_{MR}\end{matrix} ] \times [ \begin{matrix}\begin{matrix}\begin{matrix}{V}_{1} \\ {V}_{2}\end{matrix} \\ ⋮\end{matrix} \\ {V}_{R}\end{matrix} ] = [ \begin{matrix}\begin{matrix}\begin{matrix}{I}_{1} \\ {I}_{2}\end{matrix} \\ ⋮\end{matrix} \\ {I}_{M}\end{matrix} ] \qquad formula ( 2 )$$

For example, with respect to the reservoir computing apparatus as shown in FIG. 2, n reservoir sub-circuits of the reservoir computing apparatus output R (R=n×N) second processing results to the output layer circuit 30 as shown in FIG. 6. In the output layer circuit 30, the R second processing results are multiplied by the second weight matrix, to finally output n×M third processing results.

For example, the memristor sub-circuit in the memristor array of FIG. 6 may have a 1T1R structure or a 2T2R structure, the memristor sub-circuit of the 1T1R structure includes one transistor and one memristor, and the memristor sub-circuit of the 2T2R structure includes two transistors and two memristors. The memristor array may further include word lines (not shown in FIG. 6) for the respective transistors; and each word line is used to control ON or OFF of, for example, transistors in a row of memristor sub-circuits. For example, the memristor is a non-volatile memristor, including but not limited to, RRAM, PCRAM, ECRAM, Flash, etc. The structure of the memristor sub-circuit will not be limited in the present disclosure, and memristor sub-circuits in other structural forms that may implement multiply accumulation may also be adopted.

It should be noted that the transistors adopted in the embodiments of the present disclosure may be thin film transistors or field effect transistors (e.g., MOS field effect transistors) or other switching devices with same characteristics. The transistor used here may have a source electrode and a drain electrode that are symmetrical in structure, so there is no difference in structure between the source electrode and the drain electrode.

In the reservoir computing apparatus provided by the above-described embodiment, the non-volatile memristor array is applied to the output layer circuit to implement efficient multiply accumulation. In the above-described apparatus, physical characteristics of components are fully mined for RC calculation, which reduces system costs and operation power consumption within an acceptable error range.

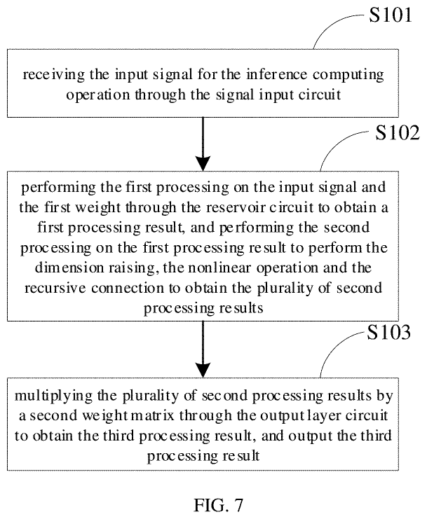

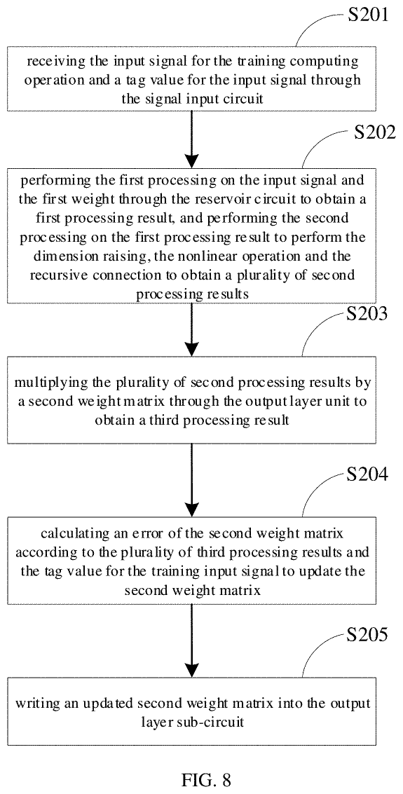

FIG. 7 is a flow chart of a data processing method provided by at least one embodiment of the present disclosure; and FIG. 8 is a flow chart of another data processing method provided by at least one embodiment of the present disclosure.

For example, the data processing method used in the above-described reservoir computing apparatus includes an inference computing operation or a training computing operation. The first weight matrix and the second weight matrix in the inference computing operation may be target values obtained by training according to an application scenario in the training computing operation, to implement functions such as classification, prediction, and recognition, etc. for the input signals.

For example, as shown in FIG. 7, in one example, the inference computing operation includes following steps of S₁₀₁ to S₁₀₃.

Step S₁₀₁: receiving the input signal for the inference computing operation through the signal input circuit 20.

Step S₁₀₂: performing the first processing on the input signal and the first weight through the reservoir circuit 10 to obtain a first processing result, and performing the second processing on the first processing result to perform the dimension raising, the nonlinear operation and the recursive connection to obtain the plurality of second processing results;

Step S₁₀₃: multiplying the plurality of second processing results by a second weight matrix through the output layer circuit 30 to obtain the third processing result, and output the third processing result.

For example, as shown in FIG. 7, when performing the inference computing operation in the reservoir computing apparatus shown in FIG. 2, the input signal is firstly received through the signal input circuit 20. Then, the signal input circuit 20 inputs the input signal to, for example, input terminals 1011 to 10n1 of n mask sub-circuits 101 to 10n shown in FIG. 3 (e.g., the input signals include n input signals 1 to n in the form of unit vectors, and the input signals 1 to n are input to n different reservoir sub-circuits 11 to 1n, respectively). In a mask sub-circuit 10i, the first processing is performed on an input signal i and the first weight corresponding to the input weight configuring sub-circuit 10i2, to obtain N first processing results 1 to N. Then, the mask sub-circuit 10i outputs the N first processing results 1 to N to, for example, the rotating neuron sub-circuits 1i shown in FIG. 4B; meanwhile, a pulse frequency matched with a time constant and a timing signal of the neuron circuit is input to the timing control circuit 11i4, and the second processing is performed on the N first processing results 1 to N in the rotating neuron sub-circuits 1i to perform the dimension raising, the nonlinear operation and the recursive connection to obtain N second processing results 1 to N at each moment. Finally, for example, the output layer circuit 30 shown in FIG. 6 collects R (R=n×N) processing results of n rotating neuron sub-circuits 111 to 11n; the R second processing results are processed through the output layer circuit 30, for example, multiplied by the second weight matrix mapped in the memristor array, to obtain n×M third processing results; and the n×M third processing results are output for subsequent processing.

For example, as shown in FIG. 8, in one example, the training computing operation includes following steps of S₂₀₁ to S₂₀₅.

Step S₂₀₁: receiving the input signal for the training computing operation and a tag value for the input signal through the signal input circuit 20.

Step S₂₀₂: performing the first processing on the input signal and the first weight through the reservoir circuit 10 to obtain a first processing result, and performing the second processing on the first processing result to perform the dimension raising, the nonlinear operation and the recursive connection to obtain a plurality of second processing results.

Step S₂₀₃: multiplying the plurality of second processing results by a second weight matrix through the output layer circuit 30 to obtain a third processing result.

Step S₂₀₄: calculating an error of the second weight matrix according to the plurality of third processing results and the tag value for the training input signal to update the second weight matrix.

Step S₂₀₅: writing an updated second weight matrix into the output layer circuit 30.

For example, as shown in FIG. 8, when performing the training computing operation in the reservoir computing apparatus shown in FIG. 2, the input signal and the tag value corresponding to the input signal are firstly received through the signal input circuit 20. Then, the signal input circuit 20 inputs the input signal to, for example, the n input terminals 1011 to 10n1 of the mask sub-circuits 101 to 10n shown in FIG. 3 (e.g., the input signal includes n input signals 1 to n in the form of unit vectors, and the input signals 1 to n are input to n different reservoir sub-circuits 11 to 1n, respectively). In the mask sub-circuit 10i, the first processing is performed on an input signal i and the first weight corresponding to the input weight configuring sub-circuit 10i2 to obtain N first processing results 1 to N. Then, a mask sub-circuit 10i outputs the N first processing results 1 to N to, for example, the rotating neuron sub-circuit 11i shown in FIG. 4B; meanwhile, a pulse frequency matched with a time constant and a timing signal of the neuron circuit is input to the timing control circuit 11i4, and the second processing is performed on the N first processing results 1 to N in the rotating neuron sub-circuit 1i to perform the dimension raising, the nonlinear operation and the recursive connection to obtain N second processing results 1 to N at each moment. Then, for example, the output layer circuit 30 as shown in FIG. 6 collects R (R=n×N) second processing results of the n rotating neuron sub-circuits 111 to 11n; the R second processing results are processed through the output layer circuit 30, for example, multiplied by the second weight matrix that is mapped in the memristor array to obtain n×M third processing results. Subsequently, an error of the second weight matrix is calculated according to the n×M third processing results and the tag value of the training input signal, for example, the error is used to calculate a loss value, and the loss value is used for back propagation to update the second weight matrix; finally, the updated second weight matrix is written into the output layer circuit 30 as shown in FIG. 6, for example, to be reset as the conductance values of the respective memristor sub-circuits in the memristor array of the memory computing integrated array.

For example, in step S₂₀₄, an algorithm such as linear regression, etc. may be adopted to update the second weight matrix, which will not be limited in the embodiments of the present disclosure. In the training process, the R second processing results output by the reservoir circuit 10 at respective moments may be taken as variables in the linear regression algorithm, and then a desired third processing result may be set as a target value of the linear regression algorithm, so as to calculate a group of second weight matrices. The parameter setting sub-circuit in FIG. 6 sets the conductance values of the memristors of M rows and R rows in the memristor array according to the second weight matrix that is obtained from training.

The following points need to be noted:

(1) In the drawings of the embodiments of the present disclosure, only the structures related to the embodiments of the present disclosure are involved, and other structures may refer to the common design(s).

(2) In case of no conflict, features in one embodiment or in different embodiments of the present disclosure may be combined.

The above are merely particular embodiments of the present disclosure but are not limitative to the scope of the present disclosure; any of those skilled familiar with the related arts may easily conceive variations and substitutions in the technical scopes disclosed by the present disclosure, which should be encompassed in protection scopes of the present disclosure. Therefore, the scopes of the present disclosure should be defined in the appended claims.

What is claimed is:

1. A reservoir computing apparatus, comprising:
a signal input circuit, configured to receive an input signal;
a reservoir circuit, comprising a plurality of reservoir sub-circuits, wherein each reservoir sub-circuit of the plurality of reservoir sub-circuits comprises:
a mask sub-circuit, configured to receive the input signal and perform a first processing on the input signal with a first weight to obtain a first processing result, and
a rotating neuron sub-circuit, configured to receive the first processing result from the mask sub-circuit, and perform a second processing on the first processing result to perform a dimension raising, a nonlinear operation and a recursive connection to obtain a second processing result; and
an output layer circuit, configured to multiply a plurality of second processing results of the plurality of reservoir sub-circuits by a second weight matrix to obtain a third processing result, and output the third processing result.

2. The reservoir computing apparatus according to claim 1, wherein the mask sub-circuit comprises:
an input terminal, configured to receive the input signal;
an input weight configuring sub-circuit, configured to receive a control signal that is related to the first weight, and perform the first processing on the input signal, which is received by the input terminal, and the first weight to obtain the first processing result; and
an output terminal, configured to output the first processing result of the input weight configuring sub-circuit.

3. The reservoir computing apparatus according to claim 2, wherein the input weight configuring sub-circuit comprises:
an inverter;
a plurality of switches, wherein each switch of the plurality of switches comprises:
a first switch input terminal,
a second switch input terminal,
a switch output terminal, and
a switch control terminal,
the first switch input terminal is connected with an input terminal of the mask sub-circuit to receive the input signal; the inverter is connected with the input terminal of the mask sub-circuit to receive the input signal and inverts the input signal to obtain an inverted input signal; the second switch input terminal is connected with the inverter to receive the inverted input signal; the switch output terminal is connected with the output terminal of the mask sub-circuit; the switch control terminal is configured to receive the control signal and output the input signal that is received by the first switch input terminal or the inverted input signal that is received by the second switch input terminal from the switch output terminal.

4. The reservoir computing apparatus according to claim 3, wherein the control signal is a random control signal.

5. The reservoir computing apparatus according to claim 1, wherein the rotating neuron sub-circuit comprises:
N front neuron rotor circuits, wherein each front neuron rotor circuit of the N front neuron rotor circuits comprises a first gate signal terminal, a first input terminal, and N first output terminals that are ranked from 1st to Nth;
N rear neuron rotor circuits, wherein the N rear neuron rotor circuits are in one-to-one correspondence with the N front neuron rotor circuits, each rear neuron rotor circuit of the N rear neuron rotor circuits comprises a second gate signal terminal, N second input terminals that are ranked from 1st to Nth and a second output terminal;
N neuron circuits, wherein a first terminal of an mth neuron circuit of the N neuron circuits is connected with an mth first output terminal of each front neuron rotor circuit of the N front neuron rotor circuits, a second terminal of the mth neuron circuit of the N neuron circuits is connected with an mth second input terminal of each rear neuron rotor circuit of the N rear neuron rotor circuits;
a timing control circuit, connected with the first gate signal terminal of each front neuron rotor circuit of the N front neuron rotor circuits, connected with the second gate signal terminal of each rear neuron rotor circuit of the N rear neuron rotor circuits, and configured to generate a gate signal, thereby applying the gate signal to the N front neuron rotor circuits and the N rear neuron rotor circuits, simultaneously,
the N front neuron rotor circuits are configured as a whole, such that each front neuron rotor circuit of the N front neuron rotor circuits gates one of the N first output terminals of its own according to the gate signal, and serial numbers of first output terminals that are gated by the N front neuron rotor circuits are different from each other,
the N front neuron rotor circuits are configured as a whole, such that each rear neuron rotor circuit of the N rear neuron rotor circuits gates one of the N second input terminals of its own according to the gate signal, and serial numbers of second input terminals that are gated by the N rear neuron rotor circuits are different from each other,
a first output terminal of a front neuron rotor circuit and a second input terminal of a rear neuron rotor circuit, which are connected with a same neuron circuit, are simultaneously gated,
N is a positive integer greater than 1, m=1, 2, . . . , N.

6. The reservoir computing apparatus according to claim 5, wherein
a value of the gate signal changes with time and causes in N operation cycles:
each front neuron rotor circuit of the N front neuron rotor circuits to gate the 1st to the Nth first output terminals of its own, sequentially, and
each rear neuron rotor circuit of the rear neuron rotor circuits to gate the 1st to the Nth second input terminals of its own, sequentially.

7. The reservoir computing apparatus according to claim 5, wherein each neuron circuit of the plurality of neuron circuits comprises:
a nonlinear activating circuit;
an integrating circuit; and
an attenuating circuit,
a first terminal of the nonlinear activating circuit is connected with an input terminal of the neuron circuit; a second terminal of the nonlinear activating circuit is connected with an output terminal of the neuron circuit; a first terminal of the integrating circuit is connected with the output terminal of the neuron circuit; a first terminal of the attenuating circuit is connected with the input terminal of the neuron circuit; and a second terminal of the integrating circuit is connected with a second terminal of the attenuating circuit.

8. The reservoir computing apparatus according to claim 7, wherein the nonlinear activating circuit comprises a diode; a negative electrode of the diode is connected with the output terminal of the neuron circuit; and a positive electrode of the diode is connected with a reference voltage terminal,
the integrating circuit comprises an integrating resistor and a capacitor; a first terminal of the integrating resistor is connected with the input terminal of the neuron circuit; a second terminal of the integrating resistor is connected with a first terminal of the capacitor and the output terminal of the neuron circuit; and a second terminal of the capacitor is connected with the reference voltage terminal,
the attenuating circuit comprises an attenuating resistor; a first terminal of the attenuating resistor is connected with the output terminal of the neuron circuit; and a second terminal of the attenuating resistor is connected with the reference voltage terminal.

9. The reservoir computing apparatus according to claim 5, wherein each front neuron rotor circuit is a first multiplexer; and
each rear neuron rotor circuit is a second multiplexer.

10. The reservoir computing apparatus according to claim 5, wherein the timing control circuit comprises:
a counter, configured to generate the gate signal under control of a clock signal.

11. The reservoir computing apparatus according to claim 1, wherein the output layer circuit comprises:
a multiply accumulating sub-circuit, configured to multiply the plurality of second processing results by the second weight matrix to obtain the third processing result.

12. The reservoir computing apparatus according to claim 2, wherein the output layer circuit comprises:
a multiply accumulating sub-circuit, configured to multiply the plurality of second processing results by the second weight matrix to obtain the third processing result.

13. The reservoir computing apparatus according to claim 3, wherein the output layer circuit comprises:
a multiply accumulating sub-circuit, configured to multiply the plurality of second processing results by the second weight matrix to obtain the third processing result.

14. The reservoir computing apparatus according to claim 4, wherein the output layer circuit comprises:
a multiply accumulating sub-circuit, configured to multiply the plurality of second processing results by the second weight matrix to obtain the third processing result.

15. The reservoir computing apparatus according to claim 5, wherein the output layer circuit comprises:
a multiply accumulating sub-circuit, configured to multiply the plurality of second processing results by the second weight matrix to obtain the third processing result.

16. The reservoir computing apparatus according to claim 11, wherein the multiply accumulating sub-circuit comprises a memristor array,
the memristor array comprises a plurality of memristors that are arranged in an array, and a plurality of conductance values of the plurality of memristors that are arranged in an array correspond to values of a plurality of elements of the second weight matrix.

17. The reservoir computing apparatus according to claim 16, wherein the output layer circuit further comprises:
a parameter setting sub-circuit, configured to set the conductance value of the memristor array.

18. A data processing method, used in the reservoir computing apparatus according to claim 1, comprising:
using the reservoir computing apparatus to perform an inference computing operation; or
using the reservoir computing apparatus to perform a training computing operation.

19. The data processing method according to claim 18, wherein the inference computing operation comprises:
receiving the input signal for the inference computing operation through the signal input circuit;
performing the first processing on the input signal and the first weight through the reservoir circuit to obtain the first processing result, and performing the second processing on the first processing result to perform the dimension raising, the nonlinear operation and the recursive connection to obtain the plurality of second processing results;
multiplying the plurality of second processing results by the second weight matrix through the output layer circuit to obtain the third processing result, and outputting the third processing result.

20. The data processing method according to claim 18, wherein the training computing operation comprises:
receiving the input signal for the training computing operation and a tag value for the input signal through the signal input circuit;
performing the first processing on the input signal and the first weight through the reservoir circuit to obtain the first processing result, and performing the second processing on the first processing result to perform the dimension raising, the nonlinear operation and the recursive connection to obtain the plurality of second processing results;
multiplying the plurality of second processing results by the second weight matrix through the output layer circuit to obtain the third processing result;
calculating an error of the second weight matrix according to the plurality of third processing results and the tag value for the training input signal to update the second weight matrix; and
writing an updated second weight matrix into the output layer circuit.
